(19) United States
(12) Patent Application Publication
(10) Pub. No.: US 2011/0205036 A1
(43) Pub. Date: Aug. 25, 2011

(54) POWER-SAVING WIRELESS INPUT DEVICE

(76) Inventor: Allen KU, Walnut, CA (US)

(21) Appl. No.: 12/710,687

(22) Filed: Feb. 23, 2010

(51) Int. Cl. G08B 5/36; G09F 9/33; G08B 1/00; H05B 37/02

(52) U.S. Cl. 340/309.9; 340/815.45; 340/815.53; 315/250

(57) ABSTRACT

This invention relates to a power-saving wireless input device. A pulse-width-modulation unit is introduced to generate a pulse-width modulator signal for controlling a light-source control unit to produce a driving signal. The driving signal is of the same duty cycle as that of the pulse-width-modulation signal so as to control the on/off of an indicator light. Furthermore, the invention introduces a timer unit to count a length of a time period between receipts of two subsequent input signals. When the length of the time period exceeds a predetermined threshold, a wireless input device is configured to be operating in a hibernation mode. Still further, an optical unit using a beam-splitting technology is introduced so that only one luminescent component may be necessary to provide light beams for the indicator lights of the wireless input device.

### BACKGROUND OF THE INVENTION

1. Field of the Invention

The present invention generally relates to a wireless input device, and more particularly, to a power-saving wireless input device.

2. Description of Related Art

Please refer to FIG. 1 illustrating a schematic diagram of a conventional wireless keyboard 10. The wireless keyboard 10 includes a plurality of indicator lights such as a first indicator light 11 (Num Lock), a second indicator light 12 (Caps Lock), and a third indicator light 13 (Scroll Lock) to at least display the status of the keyboard 10. Moreover, indicator lights such as a power indicator, a wireless connection indicator, an operating mode indicator could be further included on the wireless keyboard 10.

Those indicator lights are usually implemented by the light-emitting diode (LED). However, in practice, every LED needs a power of 3 to 5 mA to be activated. Therefore, with more indicator lights more power may be consumed, which decreases the battery life of a battery.

Despite other conventional wireless keyboards are not equipped with certain indicator lights to reduce the aforementioned power consumption, they might not provide users with information regarding the actual status of the keyboards.

### SUMMARY OF THE INVENTION

A power-saving wireless input device is provided. The wireless input device includes a micro-processing unit for generating a control signal. The device further has a pulse-width-modulation unit connected with the micro-processing unit for receiving the control signal. Based on the control signal, a pulse-width-modulation signal is generated by the pulse-width-modulation unit. Further, a light-source control unit connected with the pulse-width-modulation unit is introduced for receiving the pulse-width-modulation signal. And a driving signal is generated for an indicator light connected with the light-source control unit to receive before the indicator light could be turned on.

Another embodiment of the present invention provides the wireless input device having a micro-processing unit for generating a control signal, a light-source control unit connected to the micro-processing unit for receiving the control signal and accordingly generating a driving signal, and a plurality of indicator lights connected with the light-source control unit for receiving the driving signal before being turned on. Moreover, a timer unit is also included. The timer unit is connected with the micro-processing unit for generating a timing signal. The micro-processing unit controls the light-source control unit according to the timing signal to stop generating the driving signal.

Furthermore, another embodiment of the present invention provides a wireless input device having a micro-processing unit for generating a control signal, a light-source control unit connected to the micro-processing unit for receiving the control signal in order to generate a driving signal, and a luminescent component connected to the light-source control unit for receiving the driving signal and accordingly generating a first beam. An optical unit is further included to receive the first beam before generating a plurality of second beams by a beam splitter. The device further has a plurality of indicator lights for separately receiving the second beams.

In order to further understand the techniques, means and effects the present invention takes for achieving the prescribed objectives, the following detailed description and included drawings are hereby referred, such that, through which, the purposes, features and aspects of the present invention can be thoroughly and concretely appreciated; however, the included drawings are provided solely for reference and illustration, without any intention to be used for limiting the present invention, whose full scope and dimension is described only in the later following claims.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of a conventional wireless keyboard;

FIG. 2 is a modular diagram of a wireless input device in accordance with one embodiment of the present invention;

FIG. 3 is a modular diagram of a wireless input device in accordance with one embodiment of the present invention;

FIG. 4 is a flow chart illustrating a method for controlling the wireless input device in accordance with one embodiment of the present invention;

FIG. 5 is a modular diagram of a wireless input device in accordance with one embodiment of the present invention.

### DETAILED DESCRIPTION OF THE PREFERRED EMBODIMENTS

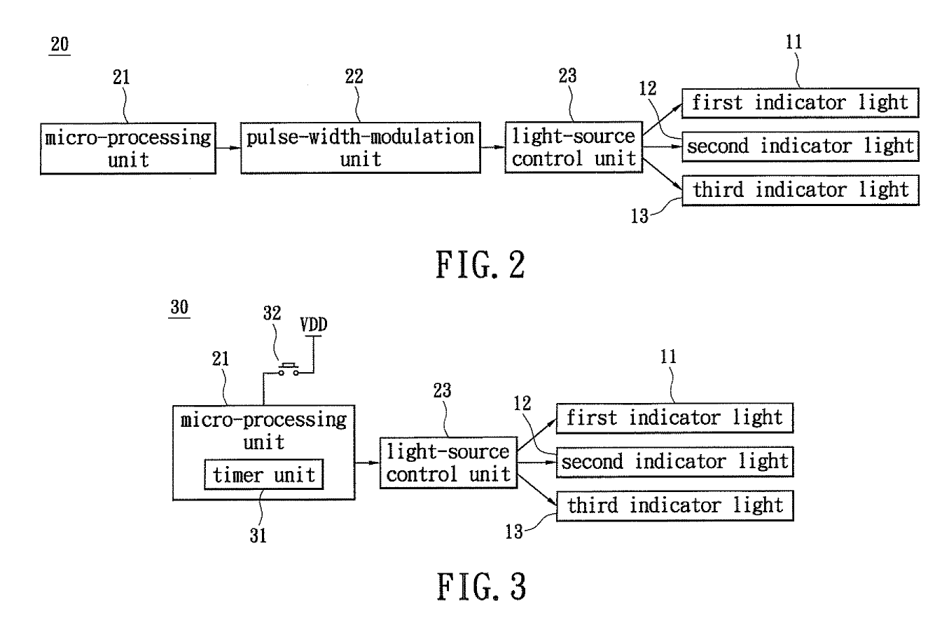

Please refer to FIG. 2 showing a modular diagram of a wireless input device 20 in accordance with one embodiment of the present invention. The wireless input device 20 includes a micro-processing unit 21, a pulse-width-modulation unit 22, a light-source control unit 23, a first indicator light 11, a second indicator light 12, and a third indicator light 13. In one implementation, the first indicator light 11 is a “Num Lock” indicator, the second indicator light 12 is a “Caps Lock” indicator, and the third indicator light 13 is a “Scroll Lock” indicator. And the wireless input device is a wireless keyboard.

The micro-processing unit 21 is configured to receive an input signal and transfer the input signal to an electronic device, such as a computer, via a wireless module (not shown). The micro-processing unit 21 is configured to generate a control signal according to a power-saving configuration. The pulse-width-modulation unit 22 is configured to generate a pulse-width-modulation signal according to the control signal from the micro-processing unit 21. The light-source control unit 23 is used to receive the pulse-width-modulation signal, and accordingly generates a driving signal for switching on the first indicator light 11, the second indicator light 12, and the third indicator light 13. In one implementation, these indicator lights are selected from light emitting diodes (LED). In another implementation, some other light sources could be available for these indicator lights.

The pulse-width-modulation signal with different duty cycles according to different configuration signals of the micro-processing unit 21. When a higher power-saving is desired, the micro-processing unit 21 accordingly generates the control signal and the pulse-width-modulation unit 22 generates the pulse-width-modulation signal with a lower duty cycle. For example, such pulse-width-modulation signal could be with a 30% duty cycle. When a low power-saving is in demand, the pulse-width-modulation signal with a higher duty cycle may be generated. One example for such pulse-width modulation signal could be a signal with a 90% duty cycle. The driving signals prepared by the light-source control unit 23 may be with different duty cycles as well. In one implementation, the driving signal may be with the same duty cycle as that of the pulse-width-modulation signal.

The driving signal of the higher duty cycle may cause the indicator light to turn on for a larger portion of time in any time period. For example, the driving signal with the 90-percent duty cycle may cause the indicator light to turn on for 90 percents of the time period and turn off for the remaining 10 percents of the same period. Such arrangement may save 10 percents of the energy consumed by the indicator light when the latter is driven by a direct current (DC) power source. Though the driving signal with the lower duty cycle may lead to reduced power consumption, the illumination intensity is lowered as well.

The pulse-width-modulation signals with the different duty cycles may thus not only reduce the power consumption of the indicator lights but also increase the batter life of the wireless input device 20. The setting of the duty cycles of the pulse-width-modulation signals may depend on the usage of the indicator lights. For example, considering the indicator lights of “Num Lock” and the “Caps Lock” are less frequently used the pulse-width-modulation signals associated with the indicator lights of “Num Lock” and “Caps Lock” may be with lower duty cycles. And thus the power consumption associated with these indicator lights could be reduced.

Please refer to FIG. 3 of a modular diagram of a wireless input device 30 according to one embodiment of the present invention. The wireless input device 30 has a micro-processing unit 21, a light-source control unit 23, a first indicator light 11, a second indicator light 12, and a third indicator light 13. The micro-processing unit 21 further includes a timer unit 31. The micro-processing unit 21 is configured to receive an input signal and to transmit the input signal to the electronic device such as a computer through a wireless module (not shown).

The micro-processing unit 21 is also configured to generate a control signal controlling the on and off of light-source control unit 23. The timer unit 31 starts to count according to the input signal. More specifically, the timer unit 31 may start counting upon a receipt of the first input signal and the counting may continue until a receipt of the second input signal wherein the second input signal may be received after the receipt of the first input signal. In another implementation, the timer unit 31 may count until a length of a time period counted exceeds a predetermined threshold. When the second input signal is received or the time period counted exceeds the predetermined threshold, a timing signal is generated. The timing signal may cause a generation of the control signal from the micro-processing unit 21 to the light-source control unit 23. And the light-source control unit 23 is configured to generate a driving signal for the indicator lights. The indicator lights could be light emitting diodes (LED) or other light sources.

In general, the user may not continuously use the wireless keyboard 10. Conventionally, the mentioned first, second and third indicator lights may not be turned off even the wireless keyboard 10 is temporarily not in use. However, the wireless input device 30 is capable of automatically detecting the usage status, and accordingly those indicator lights can be automatically turned off for the power-saving purpose.

In an exemplary example, when a first input signal indicative of the usage of the wireless input device 30 is received the timer unit 31 starts to count. If no second input signal is received during a predetermined threshold (time period), such as three minutes, the timing signal may be generated. The micro-processing unit 21 accordingly controls the light-source control unit 23 to stop generating a driving signal according to the timing signal. In the meantime, the first indicator light 11, second indicator light 12, and the third indicator light 13 may be turned off, and the wireless input device 30 enters into a hibernation mode. When the wireless input device 30 is in the hibernation mode, any receipt of another input signal may be sufficient to wake up the wireless input device 30. The input signal may cause the generation of another control signal The control signal thus may cause the light-source control unit 23 to generate a driving signal for turning on those indicator lights.

Moreover, the invention includes an indicator light switch 32 for generating a switching signal. The micro-processing unit 21 may control the on/off of the light-source control unit 23 according to the switching signal. The on/off of the light-source control unit 23 may further cause the on/off the indicator lights, and thus the total power consumption of the wireless input device 30 could be controlled.

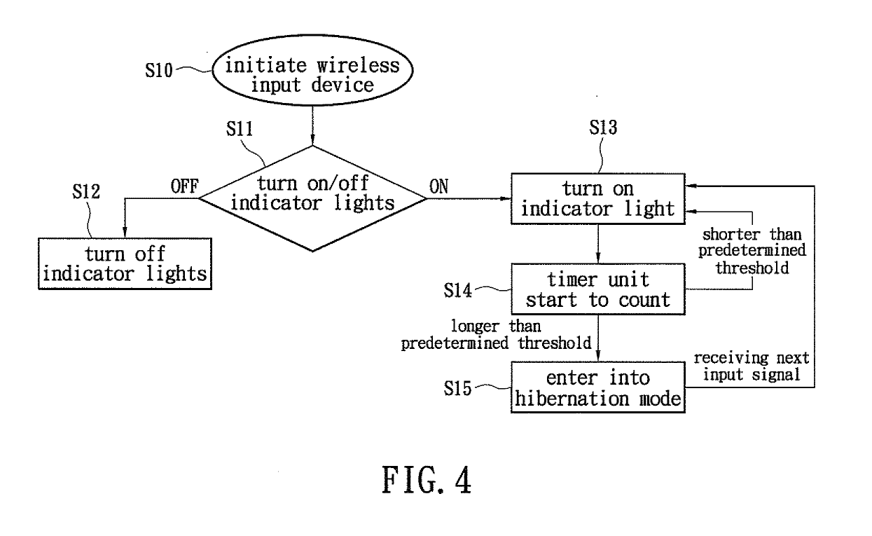

Please to FIG. 4 of a flow chart illustrating a method for controlling a wireless input device according to one embodiment of the present invention. In step S10, the user initiates the wireless input device 30. In step S11, the user may decide to switch on/off of the indicator lights through indicator-light switch 32. The indicator lights of the wireless input device 30 may be turned off as shown in step S12. The indicator lights may be turned on as shown in step S13. Thereafter, the micro-processing unit may start counting a time lapse between the input signals of the wireless input device as shown in step S14. When the length of the time period between the two subsequent input signals is less than the predetermined threshold, the indicator lights that have been turned on in S13 may remain on. Otherwise, the indicator lights may be turned off and the wireless input device may enter into the hibernation mode as shown in step S15. After that, if the user needs to turn on all the indicator lights, the user may use the indicator-light switch 32 to switch on the indicator lights in S11. Otherwise, the wireless input device 30 may wait until the receipt of the next input signal before being re-activated. The process then goes back to step S13.

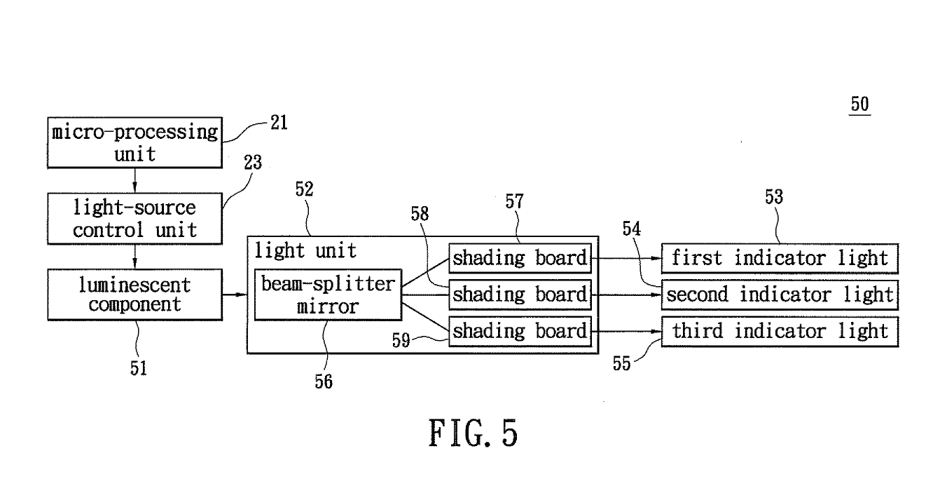

FIG. 5 shows a modular diagram of a wireless input device 50 according to one embodiment of the present invention. The wireless input device 50 includes a light-source control unit 23, a luminescent component 51, an optical unit 52, a first indicator light 53, a second indicator light 54, and a third indicator light 55. The luminescent component 51 could be implemented in form of a LED or another commercially available light source. The optical unit 52 includes a set of beam-splitter mirrors 56 and shading boards 57, 58, and 59. The optical unit 52 utilizes one beam-splitter mirror 56 to divide a first beam generated from the light source of luminescent component 51 into two or more second beams. Further, the second beams may be of different light intensities or with different angles. The second beams are separately projected onto those light indicators where corresponding shading boards associated with the light indicators may shade one or multiple projected second beams. As such, that the shading board shading the second beam may correspond to the switch-off of the indicator light associated with that particular shading board. The beam-splitter mirror 56 could be made of a prism or optical-glass coated film, and the shading boards 57, 58, and 59 can be made of any opaque material.

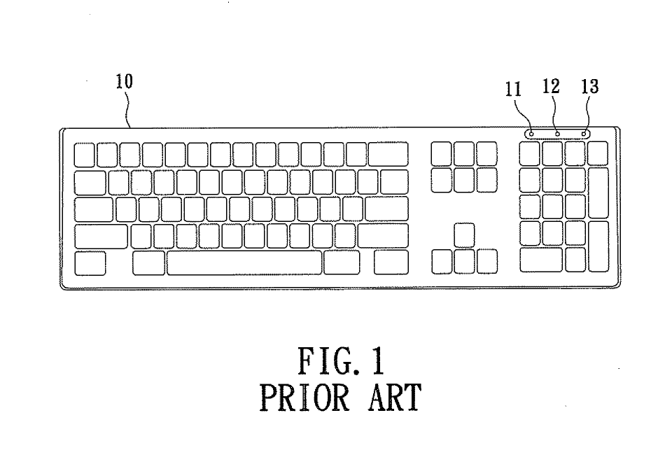

Therefore, if the user desires to turn on the first indicator light 53, the second indicator light 54 or the third indicator light 55, the wireless input device 50 merely needs to control these shading boards 57, 58, and 59 to either allow or disallow a passage of the corresponding second beam is passed, in order to turn on or turn off the indicator lights 53, 54, and 55. In other words, according to the present embodiment, only one source for the luminescent component 51 serving to emit the first beam is necessary. And the first beam may be split into three second beams by the optical unit 52 and the second beams may be projected onto the corresponding indicator lights. Therefore, the maximum power consumption of the wireless keyboard according to the embodiment of the present invention is almost one third of the conventional wireless keyboard 10 shown in FIG. 1. Moreover, the shading boards 57, 58, and 59 may be implemented by changing the polarizing angle of the beam-splitter mirror 56, causing the second beam not aim at either or all of the indicator lights so as to control on/off of the indicator lights.

Any skilled person in the art regarding the present invention can readily make any combination of the embodiments described in FIG. 2, FIG. 3 and FIG. 5 in order to reduce the power consumption of the wireless input device. For example, the timer unit 31 may be added into the wireless input device 20. Therefore, the wireless input device 20 may be capable of controlling the on/off of the indicator lights by generating the pulse-width-modulation signal and even switching off the light indicators when the length of the time period counted by the wireless input device has exceeded the predetermined threshold. As such, more power consumption may be saved.

Plus, the optical unit 52 may be added to the wireless input device 20 and the luminescent component 51 may replace the LED light source. Therefore, the pulse-width-modulation signal generated by the pulse-width-modulation unit 22 could adjust length of the time period for the luminescent component 51 to emit the light in order to reduce the total power consumption. The optical unit 52 may further reduce the usage of the LED light source when splitting the first beam into multiple second beams for the corresponding indicator lights. Additionally, the pulse-width-modulation unit 22 may further adjust the length of the time period for the luminescent component to emit the light. Consequently, the total power consumption of the wireless input device may be reduced.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A wireless input device, comprising:
a micro-processing unit for generating a control signal;
a pulse-width-modulation unit electrically connected with the micro-processing unit for receiving the control signal in order to generate a pulse-width-modulation signal accordingly;
a light-source control unit electrically connected with the pulse-width-modulation unit for receiving the pulse-width-modulation signal before generating a driving signal; and
a plurality of indicator lights electrically connected to the light-source control unit for receiving the driving signal before being switched on.

2. The device of claim 1, wherein the driving signal and the pulse-width-modulation signal have the same duty cycle.

3. The device of claim 1, wherein the indicator lights are light emitting diodes (LED).

4. The device of claim 1, wherein the indicator lights include a first indicator light, a second indicator light, and a third indicator light, wherein the first indicator light is a Num Lock indicator, the second indicator light is a Caps Lock indicator, and the third indicator light is a Scroll Lock indicator.

5. The device of claim 1, further comprising a timer unit, which is electrically connected to the micro-processing unit, wherein the micro-processing unit controls the light-source control unit according to a timing signal of the timer unit.

6. The device of claim 1, further comprising an indicator-light switch, wherein the micro-processing unit controls the light-source control unit according to a switching signal of the indicator-light switch.

7. A wireless input device, comprising:
a micro-processing unit for generating a control signal;
a light-source control unit electrically connected with the micro-processing unit for receiving the control signal before generating a driving signal accordingly;
a plurality of indicator lights electrically connected with the light-source control unit for receiving the driving signal before being switched on; and
a timer unit electrically connected with the micro-processing unit for generating a timing signal;
wherein the light-source control unit, which is controlled by the micro-processing unit, is configured to stop generating the driving signal according to the timing signal.

8. The device of claim 7, wherein the indicator lights are light emitting diodes (LED).

9. The device of claim 7, wherein the indicator lights include a first indicator light, a second indicator light, and a third indicator light, wherein the first indicator light is a Num Lock indicator, the second indicator light is a Caps Lock indicator, and the third indicator light is a Scroll Lock indicator.

10. The device of claim 7, wherein the timer unit is configured to start counting a time period as the micro-processing unit receives a first input signal until the timer unit the micro-processing unit receives a second input signal, wherein when a length of the time period exceeds a predetermined threshold the timer unit generates the timing signal, and the second input signal is subsequent to the first input signal.

11. The device of claim 10, wherein when the length of the time period exceeds the predetermined threshold, the wireless input device is configured to operate in a hibernation mode until the micro-processing unit receives the second input signal.

12. A wireless input device, comprising:
a micro-processing unit for generating a control signal;
a light-source control unit electrically connected with the micro-processing unit for receiving the control signal before generating a driving signal accordingly;
a luminescent component electrically connected with the light-source control unit for receiving the driving signal before generating a first beam accordingly;
an optical unit for receiving the first beam from the luminescent component before generating a plurality of second beams using a beam-splitter technology accordingly; and
a plurality of indicator lights each for receiving the second beam.

13. The device of claim 12, wherein the luminescent component includes a LED as a light source.

14. The device of claim 12, wherein the optical unit further comprises a beam-splitter mirror and a plurality of shading boards.

15. The device of claim 14, wherein the beam-splitter mirror is composed of a prism or an optical-glass coated film, and the beam-splitter mirror divides the first beam into the plurality of the second beams with different intensities and angles.

16. The device of claim 14, wherein the shading boards are configured to shade the respective second beams in order to turn off the corresponding indicator lights.

17. The device of claim 12, further comprising a pulse-width-modulation unit electrically connected with the micro-processing unit for receiving the control signal before generating a pulse-width-modulation signal accordingly wherein the pulse-width-modulation signal having a first duty cycle is received by the light-source control unit, which is configured to generate the driving signal having a second duty cycle for driving the luminescent component wherein the first duty cycle is substantially the same as the second duty cycle.

18. The device of claim 12, further comprising a timer unit electrically connected with the micro-processing unit for generating a timing signal, wherein the timer unit is configured to start counting a time period as the micro-processing unit receives a first input signal until the micro-processing unit receives a second input signal, the timing signal is generated when a length of the time period exceeds a predetermined threshold, the micro-processing unit controls the light-source control unit to stop generating the driving signal according to the timing signal, and the wireless input device is configured to operate in a hibernation mode until the micro-processing unit receives the second input signal.

19. The device of claim 12, wherein the plurality of indicator lights include a first indicator light, a second indicator light, and a third indicator light, wherein the first indicator light is a Num Lock indicator, the second indicator light is a Caps Lock indicator, and the third indicator light is a Scroll Lock indicator.
